(19) United States
(12) Patent Application Publication
(10) Pub. No.: US 2013/0215068 A1
(43) Pub. Date: Aug. 22, 2013

(54) TRANSPARENT ELECTRODE FILM STRUCTURE AND TOUCH SCREEN

(71) Applicants: Seongman Jeon, Seoul (KR); Mangeun Kim, Seoul (KR); Hyunkwon Shin, Seoul (KR); Sangcheon Kim, Seoul (KR)

(72) Inventors: Seongman Jeon, Seoul (KR); Mangeun Kim, Seoul (KR); Hyunkwon Shin, Seoul (KR); Sangcheon Kim, Seoul (KR)

(73) Assignee: LG ELECTRONICS INC., Seoul (KR)

(21) Appl. No.: 13/881,153

(22) PCT Filed: Feb. 23, 2012
(86) PCT No.: PCT/KR2012/001396

§ 371 Date: Apr. 24, 2013

(30) Foreign Application Priority Data
Mar. 17, 2011 (KR) 10-2011-0023772

(51) Int. Cl. G02B 1/08; G06F 3/041; G02B 1/11

(52) U.S. Cl. CPC G02B 1/08; G02B 1/111; G06F 3/041
USPC 345/173; 359/488.01

(57) ABSTRACT

Disclosed is a transparent electrode film structure and a touch screen, the structure including a retarder film, first and second hard coating layers coated on both surfaces of the retarder film, an optical layer formed on the second hard coating layer, and a transparent electrode film formed on the optical layer.

### BACKGROUND OF THE DISCLOSURE

1. Field of Endeavor

Exemplary embodiments of the present disclosure relate to a transparent electrode film structure and a touch screen.

2. Discussion of the Related Art

This section provides background information related to the present disclosure which is not necessarily prior art.

Recently, with quantum leap in multimedia and display technologies, resolution of a crystal liquid display unit on mobile communication devices has improved, and as a result thereof, the mobile communication devices have increasingly adopted a touch screen. That is, terminals such as PDA (Personal Digital Assistants), PMP (Portable Multimedia Players), MP3 players and mobile phones become gradually miniaturized and compact in size for easy portability and movement.

Hence, a touch screen method instead of a conventional key button input method has been used to enable a user to select and input information more conveniently. The touch screen method is configured to directly input information into or directly output information from a computer on a screen via interface with the computer, where the user can learn a coordinate of a particular position, in a case a user hand or an object touches the particular position or character displayed on the screen, and a particular process including an application corresponding to the coordinate can be implemented. Thus, the touch screen can provide a function as an information display unit and a function as an input unit as well.

The touch screen or a touch window may variably include, based on operating principles, a capacitive overlay type touch screen, a surface acoustic wave (SAW) type touch screen, a resistive overlay type touch screen, a tactile sensor type touch screen, a piezoelectric touch screen, and an infrared beam type touch screen.

In a typical resistive overlay type touch screen, resistive materials are coated on glass or transparent plastic plate, on which polyester film is covered, where an insulating rod is installed between two surfaces at a predetermined distance to prevent two surfaces from being contacted. At this time a resistance value is changed to in turn change a voltage, and a position of a touched finger can be recognized by the changed degree of voltage.

That is, an operating principle of the resistive overlay touch screen is as follows: If voltage is applied to electrodes arranged in parallel with both sides of a transparent resistive film, electric potential is distributed between the electrodes. Since the resistance of the resistive film is uniform, the electric potential is linearly distributed and thus linear relation is seen between distance and the electric potential. The voltage is applied to a lower electrode, and voltage at a touched point is detected by an upper electrode and converted into a digital value through an analog/digital (A/D) converter, thereby calculating a position on an X-axis. Furthermore, the voltage is applied to the upper electrode, and the voltage is detected by the lower electrode and converted into a digital value in the same manner, thereby calculating a position on a Y-axis. Then, a coordinate value of a point touched by a finger or a stylus can be finally determined.

The surface acoustic wave (SAW) type touch screen is configured such that a transmitter emitting sound wave is attached to one side of a glass, and a reflector reflecting sound wave at a predetermined interval is attached, and a receiver is attached to the opposite side, where a time point when an object obstructing the sound wave such as a finger obstructs an advancing path of the sound wave is calculated to recognize a touched area.

The infrared beam type touch screen is to use linearity of infrared invisible to human eyes, where an infrared LED which is a light emitting device and a light receiving device which is a photo-transistor are mutually oppositely aligned to form a matrix, and a touched area is recognized by detecting a sensor where light is interrupted within the matrix by an object such as a finger.

The capacitive overlay touch screen is configured such that, in a case a transparent special conductive metal is coated on both surfaces of a glass and is applied with a voltage to four corners of the screen, a high frequency is generated on a surface of touch screen, and a high frequency waveform changing during touch by a user finger is analyzed by a controller to recognize a touched area.

### SUMMARY OF THE DISCLOSURE

This section provides a general summary of the disclosure, and is not a comprehensive disclosure of its full scope or all of its features.

Accordingly, the present disclosure is to provide a transparent electrode film structure and a touch screen configured to reduce reflectivity and to improve transmittance.

It should be emphasized, however, that the present disclosure is not limited to a particular disclosure as explained above. It should be understood that other technical subjects not mentioned herein may be appreciated by those skilled in the art.

In one general aspect of the present disclosure, there is provided a transparent electrode film structure, the structure comprising:

a retarder film;
an optical layer formed on the retard film; and
a transparent electrode film formed on the optical layer and consisting of a conductive polymeric film or a graphene.

In some exemplary embodiments, the structure may further comprise first and second hard coating layers coated on both surfaces of the retarder film, wherein the optical layer is formed on any one layer of the first and second hard coating layers.

In some exemplary embodiments, the optical layer may have a stacked structure with at least two or more layers.

In some exemplary embodiments, the stacked optical layer may be alternately stacked with a high refractive layer and a low refractive layer.

In some exemplary embodiments, the retarder film may be a COP (Cyclic Olefin Polymer) film or a COC (Cyclic Olefin Copolymer) film.

In another general aspect of the present disclosure, there is provided a touch screen, the touch screen comprising:

a first retarder;
a laminate structure formed on the first retarder and including a transparent electrode formed with any one of an Ag-wire ink, a conductive polymer and a graphene on at least one or more isotropic films; a second retarder formed on the laminate structure;
a touch panel including a polarizer formed on the second retarder; and a display panel coupled to a first retarder side of the touch panel.

In some exemplary embodiments, the first retarder may be further formed with a PMMA layer, and the display panel is separated from or bonded to the PMMA layer.

In some exemplary embodiments, the first retarder or the second retarder may be any one of a 1λ/4 plate, a 1λ/2 plate and a 3λ/4 plate.

In some exemplary embodiments, the first retarder or the second retarder may be a COP (Cyclic Olefin Polymer) film or a COC (Cyclic Olefin Copolymer) film.

In some exemplary embodiments, light incident from outside may be converted to a circularly polarized light of any one direction while passing the polarizer and the second retarder.

In some exemplary embodiments, the second retarder may convert a light reflected from the light incident from the outside to a linear polarized light.

In some exemplary embodiments, light emitted from the display panel may be converted to a circularly polarized light of any one direction while passing the first retarder, and converted to a linear polarized light parallel with a polarizing axis of the polarizer while passing the second retarder.

In still another general aspect of the present disclosure, there is provided a touch screen, the touch screen comprising:

an isotropic film;
a first retarder positioned at an upper surface of the isotropic film;
a second retarder positioned at an upper surface of the first retarder;
a transparent electrode formed on each of the isotropic film, the first retarder and the second retarder with any one of Ag-wire ink, a conductive polymer and a graphene;
a touch panel including a polarizer formed on an upper surface of the second retarder; and
a display panel coupled to the touch panel.

In some exemplary embodiments, the isotropic film may be further formed with a PMMA layer, and the display panel is separated from or bonded to the PMMA layer.

In some exemplary embodiments, a transparent electrode may be interposed between the first retarder and the second retarder, between the second retarder and the isotropic film and between the isotropic film and the PMMA layer.

In some exemplary embodiments, the first retarder or the second retarder may be any one of a 1λ/4 plate, a 1λ/2 plate and a 3λ/4 plate.

In some exemplary embodiments, the first retarder or the second retarder may be a COP (Cyclic Olefin Polymer) film or a COC (Cyclic Olefin Copolymer) film.

In some exemplary embodiments, light incident from outside may be converted to a circularly polarized light of any one direction while passing the polarizer and the second retarder.

In some exemplary embodiments, the second retarder may convert a light reflected from the light incident from the outside to a linear polarized light.

In some exemplary embodiments, light emitted from the display panel may be converted to a circularly polarized light of any one direction while passing the first retarder, and converted to a linear polarized light parallel with a polarizing axis of the polarizer while passing the second retarder.

In an advantageous effect, the transparent electrode film structure according to exemplary embodiments of the present disclosure is disposed with a conductive polymeric film or a graphene film to reduce reflectivity and yet to improve transmittance, such that, in a case the transparent electrode film structure according to exemplary embodiments of the present disclosure is applied to a touch screen, degraded visibility of a display caused by superficial reflection of the touch screen under indoor and outdoor operating environments can be improved to enhance the transmittance and the brightness of the display.

In another advantageous effect, the touch screen according to exemplary embodiments of the present disclosure is disposed with a transparent electrode formed with any one of Ag-wire ink, a conductive polymer and a graphene, whereby the touch screen is formed with a structure of circularly polarizing method to reduce reflectivity and yet to improve transmittance and to improve visibility of screen.

### BRIEF DESCRIPTION OF THE DRAWINGS

The above and/or other aspects of the present disclosure will become apparent and more readily appreciated from the following description of the exemplary embodiments, taken in conjunction with the accompanying drawings of which:

FIG. 1 is a conceptual cross-sectional view explaining a transparent electrode film structure according to an exemplary embodiment of the present disclosure;

FIG. 2 is a conceptual cross-sectional view explaining a comparative example of a transparent electrode film structure according to an exemplary embodiment of the present disclosure;

FIG. 3 is a graph that has measured a transmittance of a conductive polymeric film and an ITO film according to an exemplary embodiment of the present disclosure;

FIG. 4 is a conceptual cross-sectional view explaining a reflectivity of a transparent electrode film structure according to an exemplary embodiment of the present disclosure;

FIG. 5 is a photograph that has photographed a transparent electrode in a structure of FIG. 4;

FIG. 6 is a conceptual cross-sectional view explaining a reflectivity of a transparent electrode film structure according to another exemplary embodiment of the present disclosure;

FIG. 7 is a photograph that has photographed a transparent electrode in a structure of FIG. 6;

FIG. 8 is a conceptual cross-sectional view explaining a touch screen of a first exemplary embodiment applied with a transparent electrode film according to the present disclosure;

FIG. 9 is a conceptual cross-sectional view explaining another example of a touch screen of a first exemplary embodiment applied with a transparent electrode film according to the present disclosure;

FIG. 10 is a conceptual cross-sectional view explaining a touch screen of a second exemplary embodiment applied with a transparent electrode film according to the present disclosure;

FIG. 11 is a conceptual cross-sectional view explaining another example of a touch screen of a second exemplary embodiment applied with a transparent electrode film according to the present disclosure;

FIG. 12 is a photograph of a touch screen of a circularly polymeric method applied with a transparent electrode film according to the present disclosure; and

FIG. 13 is a photograph of a touch screen of a non-circular polymeric method applied with an ITO film according to a comparative example of the present disclosure.

### DETAILED DESCRIPTION OF PREFERRED EMBODIMENTS

The following description is merely exemplary in nature and is not intended to limit the present disclosure, application, or uses.

Advantages and features of the present disclosure may be understood more readily by reference to the following detailed description of exemplary embodiments and the accompanying drawings. Detailed descriptions of well-known functions, configurations or constructions are omitted for brevity and clarity so as not to obscure the description of the present disclosure with unnecessary detail. Thus, the present disclosure is not limited to the exemplary embodiments which will be described below, but may be implemented in other forms. In the drawings, the width, length, thickness, etc. of components may be exaggerated or reduced for the sake of convenience. Furthermore, throughout the descriptions, the same reference numerals will be assigned to the same elements in the explanations of the figures, and explanations that duplicate one another will be omitted.

Accordingly, the meaning of specific terms or words used in the specification and claims should not be limited to the literal or commonly employed sense, but should be construed or may be different in accordance with the intention of a user or an operator and customary usages. Therefore, the definition of the specific terms or words should be based on the contents across the specification.

Now, exemplary embodiments of the present disclosure will be described in detail with reference to the accompanying drawings.

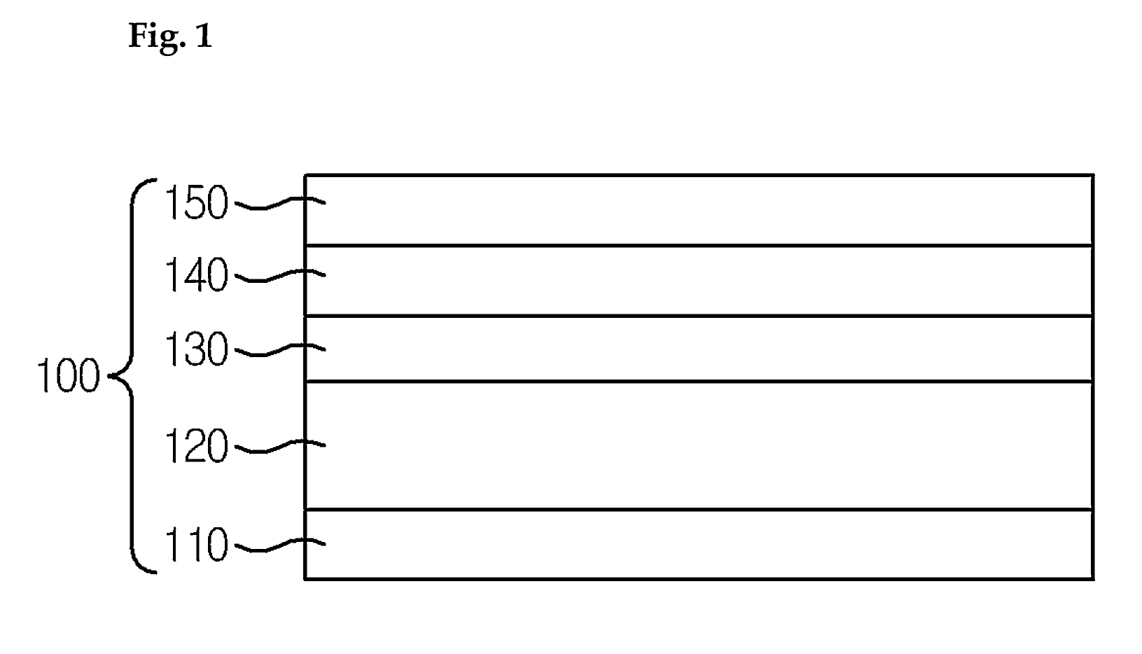

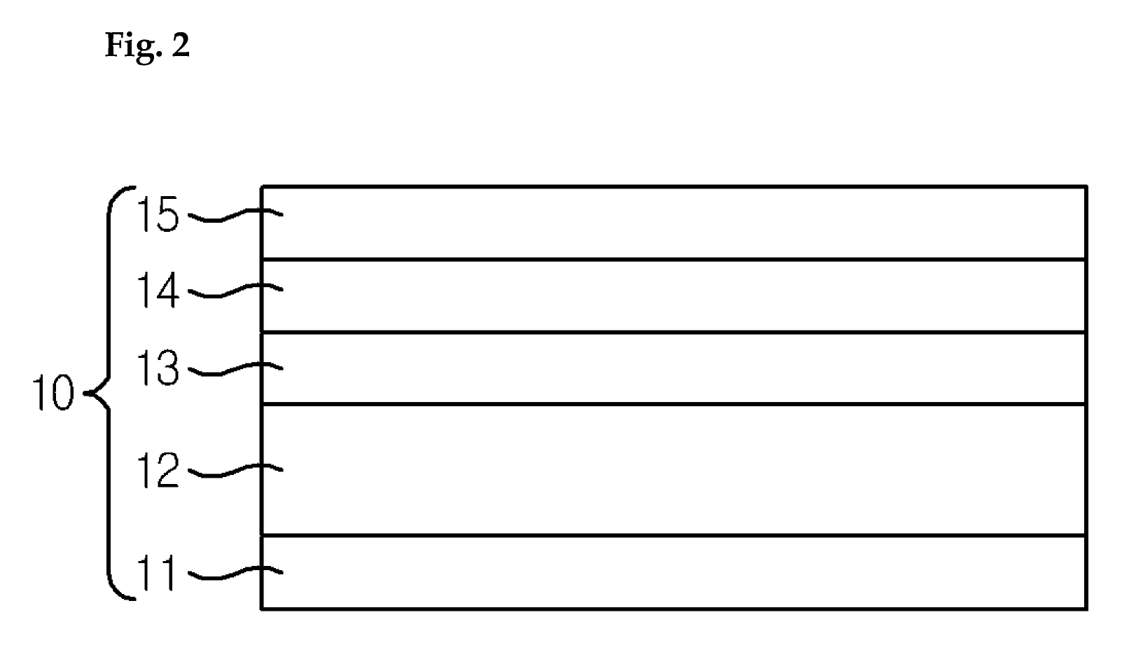

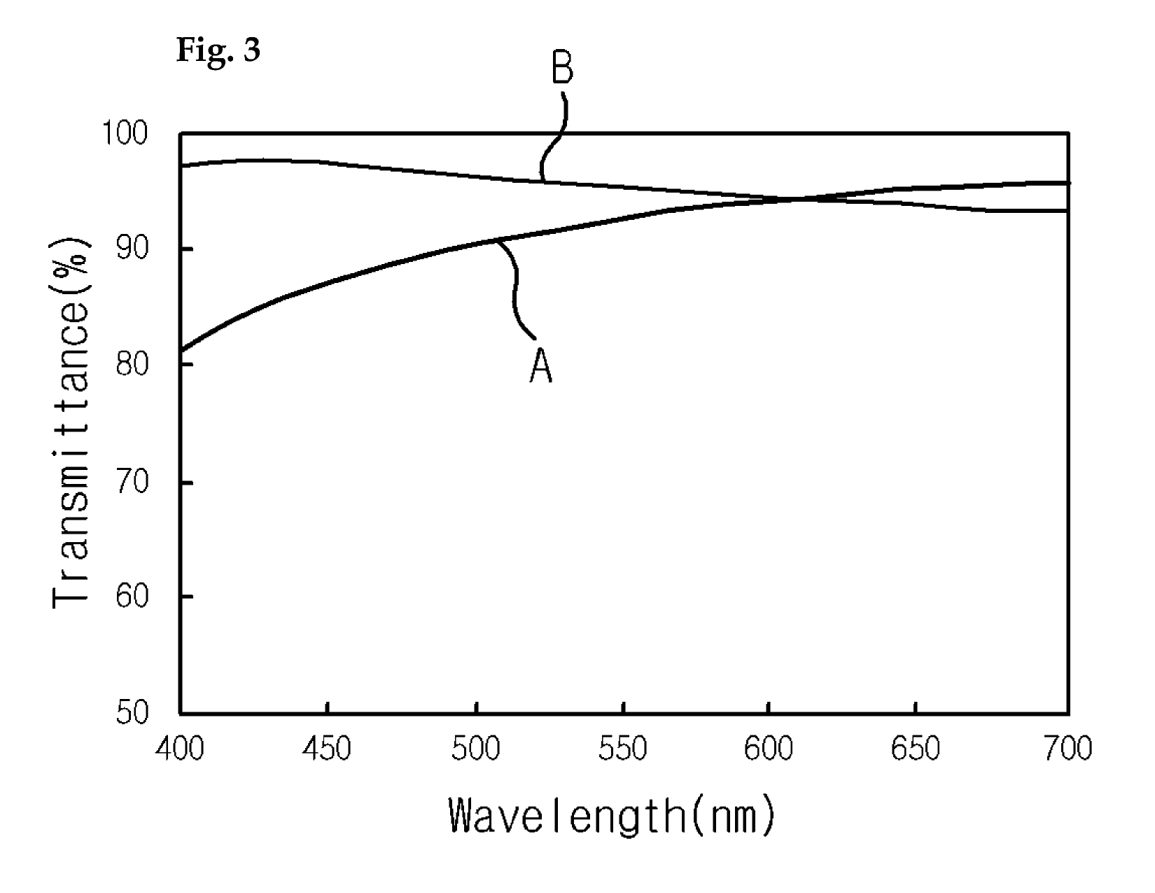

FIG. 1 is a conceptual cross-sectional view explaining a transparent electrode film structure according to an exemplary embodiment of the present disclosure, FIG. 2 is a conceptual cross-sectional view explaining a comparative example of a transparent electrode film structure according to an exemplary embodiment of the present disclosure, and FIG. 3 is a graph that has measured a transmittance of a conductive polymeric film and an ITO film according to an exemplary embodiment of the present disclosure.

Referring to FIG. 1, a transparent electrode film structure according to the present disclosure includes a retarder film 120, first and second hard coating layers 110, 130 coated on both surfaces of the retarder film 120, an optical layer 140 formed on the second hard coating layer 130 and a transparent electrode film 150 formed on the optical layer 140, where the first and second hard coating layers 110, 130 are coated to increase the hardness of the retarder film 120, materials of the first and second hard coating layers 110, 130 are preferably polymers, and the transparent electrode film 150 may be realized by a conductive polymeric film or a graphene film.

Furthermore, the retarder film 120 may be a COP (Cyclic Olefin Polymer) film or a COC (Cyclic Olefin Copolymer) film. In a case the retarder film 120 is applied with a PET film, there may be developed a phenomenon of decreased polarizing function due to influence resultant from phase change. Since the COP film or the COC film can minimize the influence by the phase change, the decreased polarizing function can be avoided.

Meantime, referring to FIG. 2, the transparent electrode film structure in the comparative example includes a PET (Polyethylene Terephthalate) film 12, hard coating layers 11, 13 coated on both surfaces of the PET film 12, an optical layer 14 formed on the hard coating layer 13 and an ITO (Indium Tin Oxide) electrode film 15 formed on the optical layer 14. The transparent electrode film structure in the comparative example uses the ITO electrode film 15 having a maximum reflectivity of 16%˜18% of outside light to decrease visibility of display, and transmittance of the ITO electrode film 15 also has reflectivity of 89%˜90% level to generate a degraded quality of display.

In order to cope with these disadvantages, the transparent electrode film structure according to an exemplary embodiment of the present disclosure includes a conductive polymeric film or a graphene film to reduce reflectivity and yet to enhance transmittance, such that in a case the transparent electrode film structure according to an exemplary embodiment of the present disclosure is used for a touch screen, the decreased visibility of display caused by superficial reflection from the touch screen under indoor and outdoor operating environment can be advantageously improved to enhance the transmittance and to increase the brightness of the display.

That is, as illustrated in FIG. 3, a conductive polymeric film (B) has a higher transmittance than that of ITO film (A) in 400 nm˜600 nm wave length bands, whereby the transparent electrode film structure formed with the conductive polymeric film according to an exemplary embodiment of the present disclosure can increase the transmittance over the comparative example having the ITO film while reducing the reflectivity.

Furthermore, since refractive index of graphene film is 1.3 and that of the ITO film is in the range of 1.9˜2.0, and the refractive index of graphene is nearer to that of air than that of the ITO film, the graphene film can increase the transmittance and yet to reduce the reflectivity, such that the transparent electrode film structure formed with the graphene film according to an exemplary embodiment of the present disclosure can reduce the reflectivity and yet to increase the transmittance over the comparative example having the ITO film.

In addition, although the transparent electrode film structure in the comparative example is based with a PET film having a double refraction to degrade the circularly polarizing performance, to cause a changed color on the display or to reduce the effect of limiting the reflection, the transparent electrode film structure according to an exemplary embodiment of the present disclosure is based on a retarder film to solve the problem resultant from use of PET film.

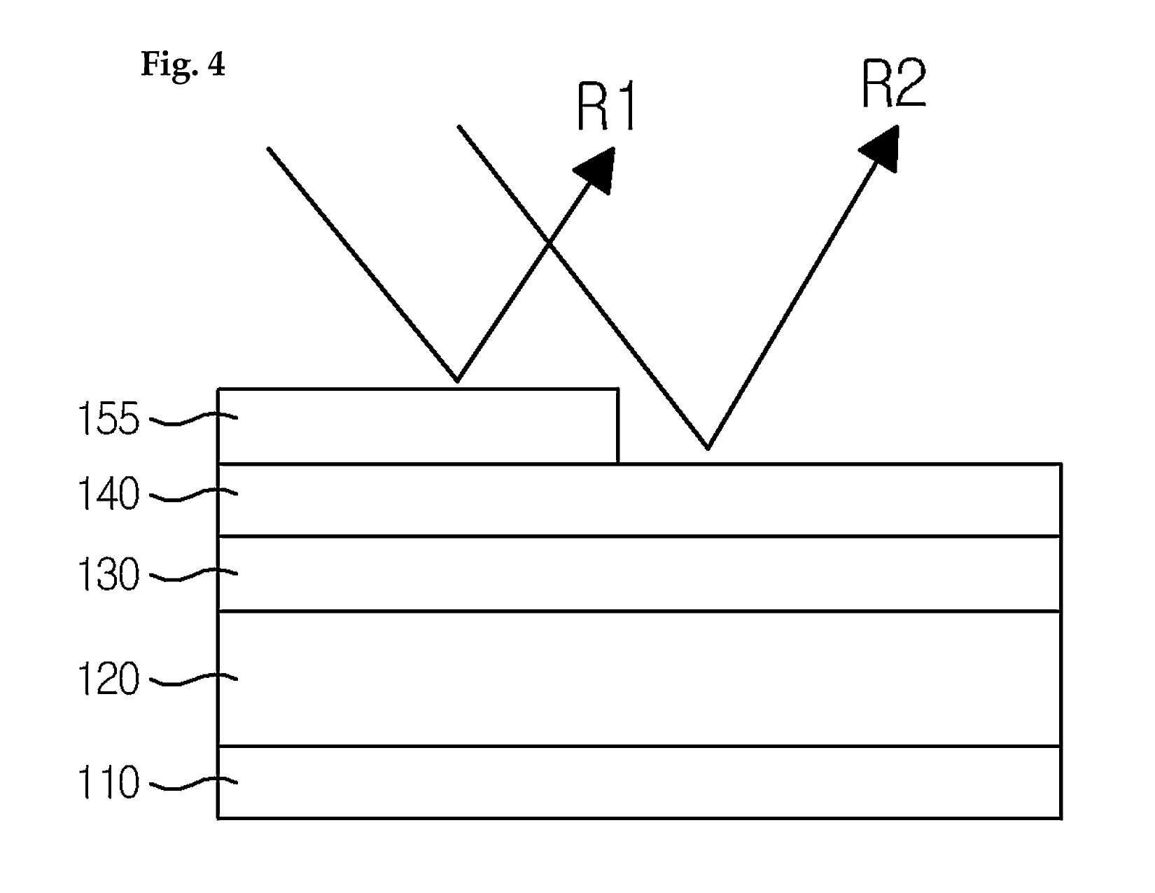

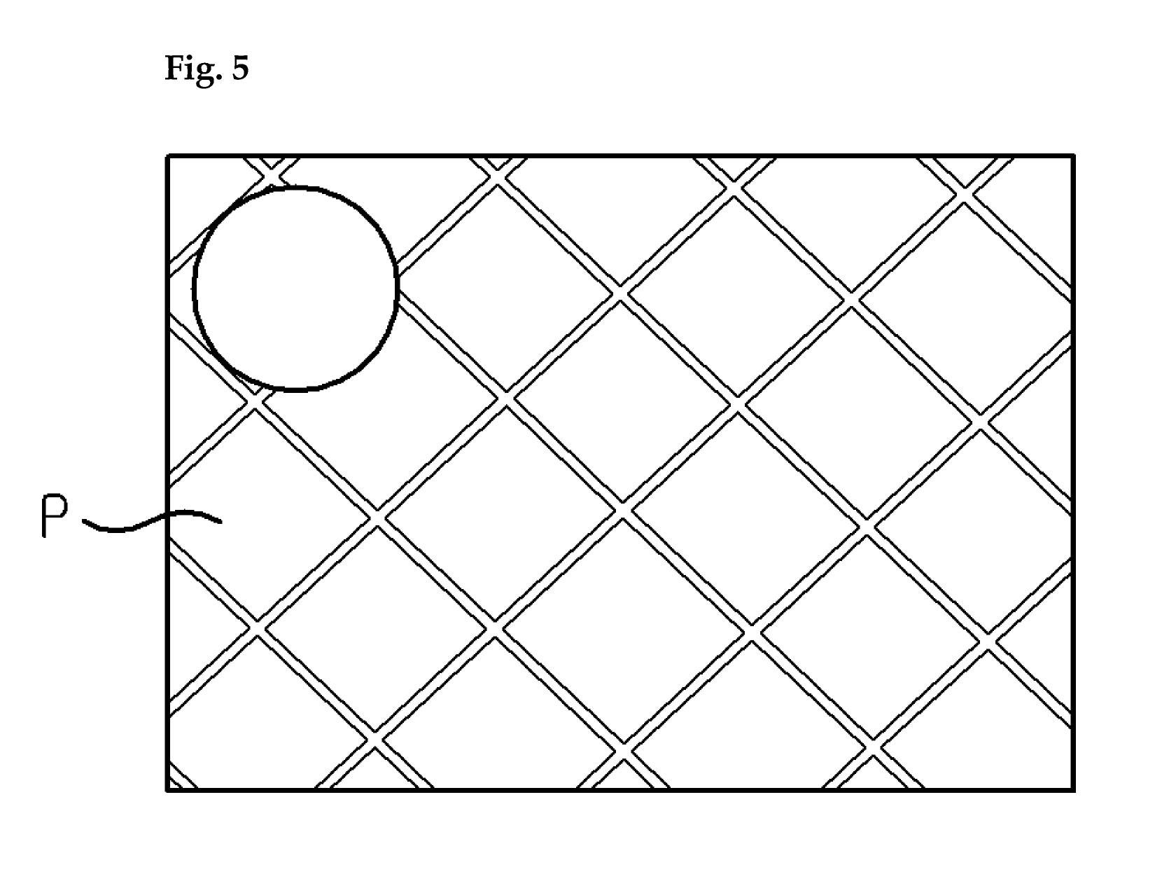

FIG. 4 is a conceptual cross-sectional view explaining a reflectivity of a transparent electrode film structure according to an exemplary embodiment of the present disclosure, and FIG. 5 is a photograph that has photographed a transparent electrode in a structure of FIG. 4.

Hence, as illustrated in FIG. 4, a transparent electrode pattern 155 is formed at an upper surface of an optical layer 140, an area exposed with the optical layer 140 by the transparent electrode pattern 155 is generated.

At this time, in a case reflectivity of outside light at an upper surface of the transparent electrode pattern 155 is defined as “R1”, and reflectivity of outside light at an upper surface of the optical layer 140 is defined as “R2”, the transparent electrode film structure of FIG. 4 can be defined as ^{Δ}R=|R1−R2|>1%, whereby, as illustrated in FIG. 5, a transparent electrode pattern ‘P’ can be seen with the naked eye.

That is, a difference of reflectivity is generated by a difference in refractive index between the optical layer 140 of the transparent electrode film structure and the transparent electrode pattern 155, and the transparent electrode pattern 155 can be seen by the naked eye of a user using a touch screen to create an interference on the screen, whereby inconvenience to the user and degraded screen quality can be resulted.

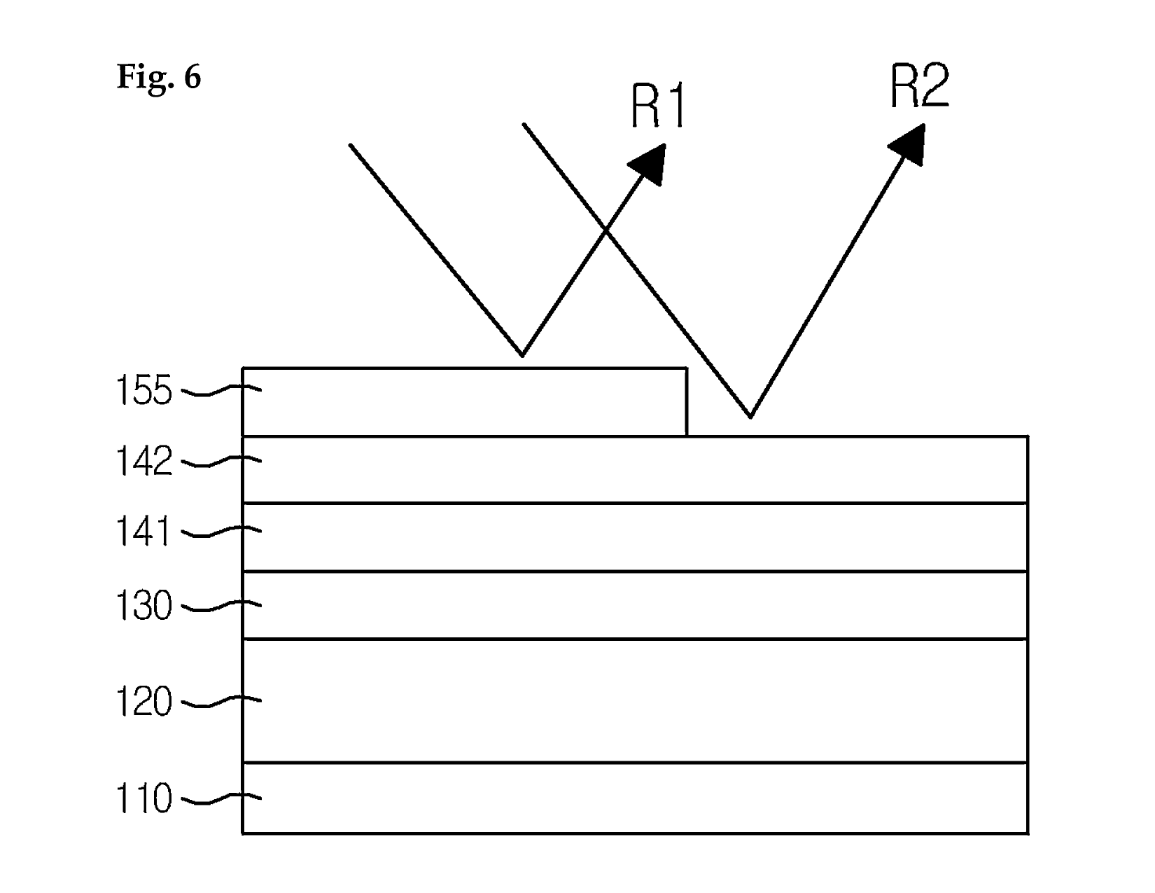

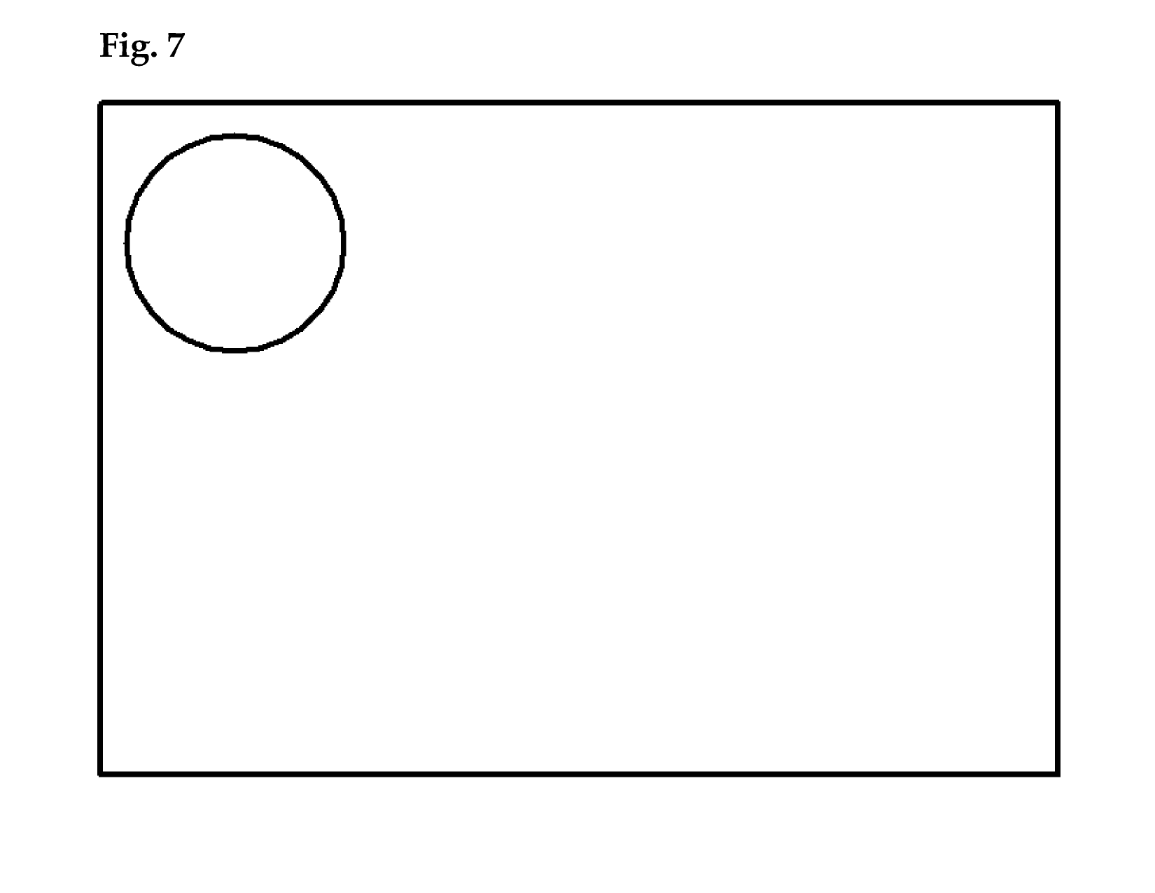

FIG. 6 is a conceptual cross-sectional view explaining a reflectivity of a transparent electrode film structure according to another exemplary embodiment of the present disclosure, and FIG. 7 is a photograph that has photographed a transparent electrode in a structure of FIG. 6.

As in the foregoing explanations in FIGS. 4 and 5, the transparent electrode film structure according to the present disclosure may be explained in another example.

That is, the transparent electrode film structure according to the present disclosure may be explained in another example.

That is, the transparent electrode film structure according to another example is stacked with at least two or more layers of optical layer with a design of ^{Δ}R=|R1−R2|<1%, whereby quality degradation caused by interference can be prevented. At this time, it is preferable that the stacked optical layer be alternately stacked with a high refractive layer and a low refractive layer, whereby the condition of ^{Δ}R=|R1−R2|<1% can be satisfied.

In addition, as illustrated in FIG. 6, the optical layer is stacked with a ‘141’ layer and a ‘142’ layer. Hence, as illustrated in FIG. 7, the transparent electrode pattern cannot be seen in the transparent electrode film structure.

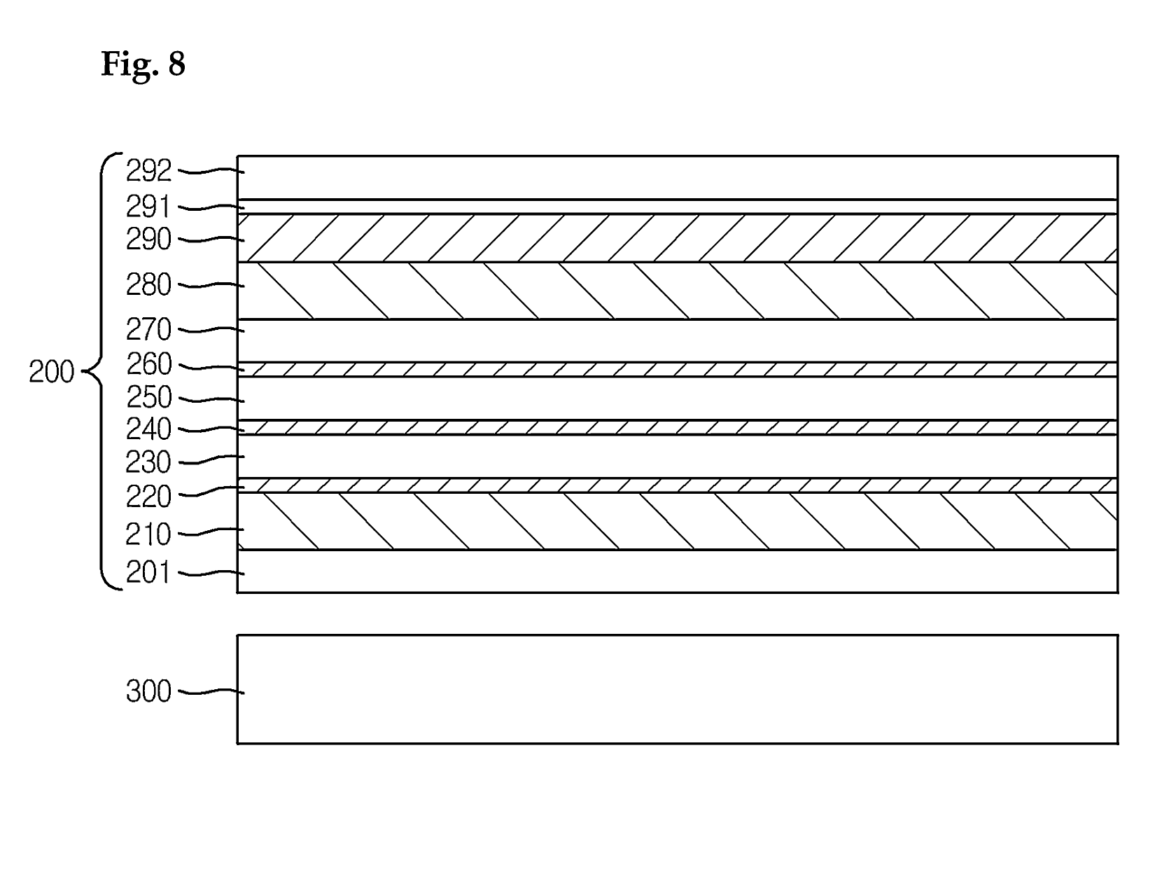

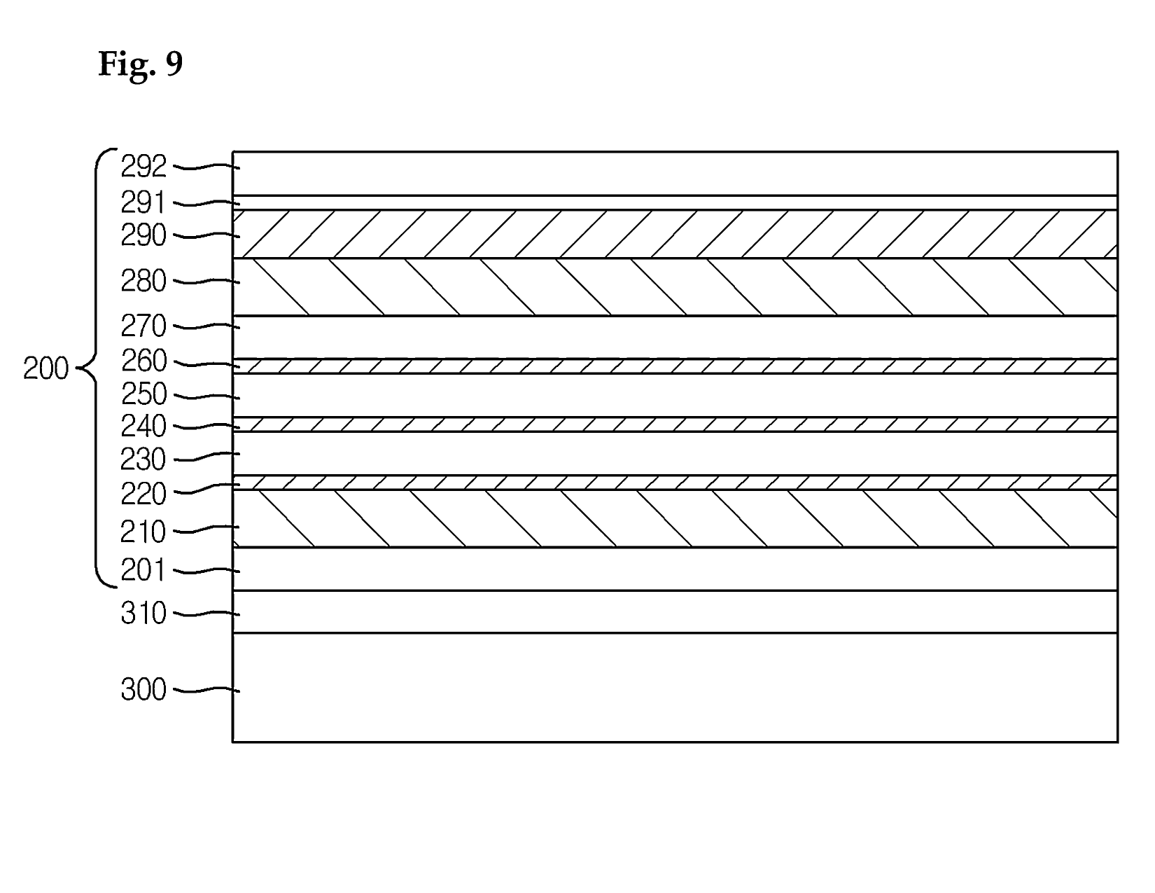

FIG. 8 is a conceptual cross-sectional view explaining a touch screen of a first exemplary embodiment applied with a transparent electrode film according to the present disclosure, and FIG. 9 is a conceptual cross-sectional view explaining another example of a touch screen of a first exemplary embodiment applied with a transparent electrode film according to the present disclosure.

A touch screen according to the present disclosure includes a transparent electrode formed with any one of Ag-wire ink, a conductive polymer and a graphene in a structure of a circularly polarizing method to reduce reflectivity, to increase transmittance, and to improve visibility of a screen.

That is, the touch screen according to the first exemplary embodiment of the present disclosure includes a first retarder 210, a laminate structure formed on the first retarder 210 and including three (3) transparent electrodes 220, 240, 260 formed with any one of an Ag-wire ink, a conductive polymer and a graphene on three (3) isotropic films 230, 250, 270, a second retarder 280 formed on the laminate structure, a touch panel 200 including a polarizer 290 formed on the second retarder 280, and a display panel 300 coupled to the touch panel 200.

At this time, the touch panel 200 may further include a window substrate 292 bonded to the polarizer 290 using an adhesive 291, and the first retarder 210 may be formed with a PMMA (PolyMethyMethAcrylate) layer 201. In addition, the display panel 300 may be adopted by an LCD panel.

Furthermore, the display panel 300 may be separated from the PMMA layer 210 as shown in FIG. 8 and the display panel 300 may be bonded to the PMMA layer 210 using an adhesive 310, as shown in FIG. 9.

Still furthermore, each of the first retarder 210 and the second retarder 280 is preferably a 1λ/4 plate, and may be a 1λ/2 plate and a 3λ/4 plate.

Hence, the touch screen according to the first exemplary embodiment of the present disclosure is configured such that, in a case an electrostatic force is generated by a user touch using a polarizer 290, a capacitance value is changed on the transparent electrodes 220, 240, 260 of the laminate structure corresponding to the touched area, whereby a coordinate value of the touched area can be detected by the changed capacitance value.

Hereinafter, the description of an optical path on the touch screen will be based on an assumption that each of the second retarder 280 and the first retarder 210 are a 1λ/4 plate.

First, in a case an outside light is incident on the touch screen, the light passes the polarizer 290, and is changed to a clockwise circularly polarized light by the second retarder 280.

In a case the clockwise circularly polarized light is reflected, the clockwise circularly polarized light is changed in direction to become a linear polarized state by the second retarder 280, and the reflected light of linear polarized state becomes orthogonal to the polarizer 290 to be prevented from being discharged to outside.

Furthermore, light emitted from the display panel 300 is changed to a clockwise circularly polarized state by the first retarder 210, passes the second retarder 280 and is changed to a linear polarized state. The linear polarized light that has passed the second retarder 280 is parallel with a polarizing axis of the polarizer 290, such that the light emitted from the display panel 300 can be discharged to the outside without any loss.]

After all, the touch screen according to the present disclosure has an advantageous effect in that the touch screen is applied with a structure of circularly polarized method, and even if an outside light is present, visibility of screen can be improved, whereby reflectivity of outside light can be reduced, and in a case the transparent electrodes 220, 240 and 260 are of a conductive polymeric film or of a graphene film, reflectivity can be reduced to thereby increase transmittance.

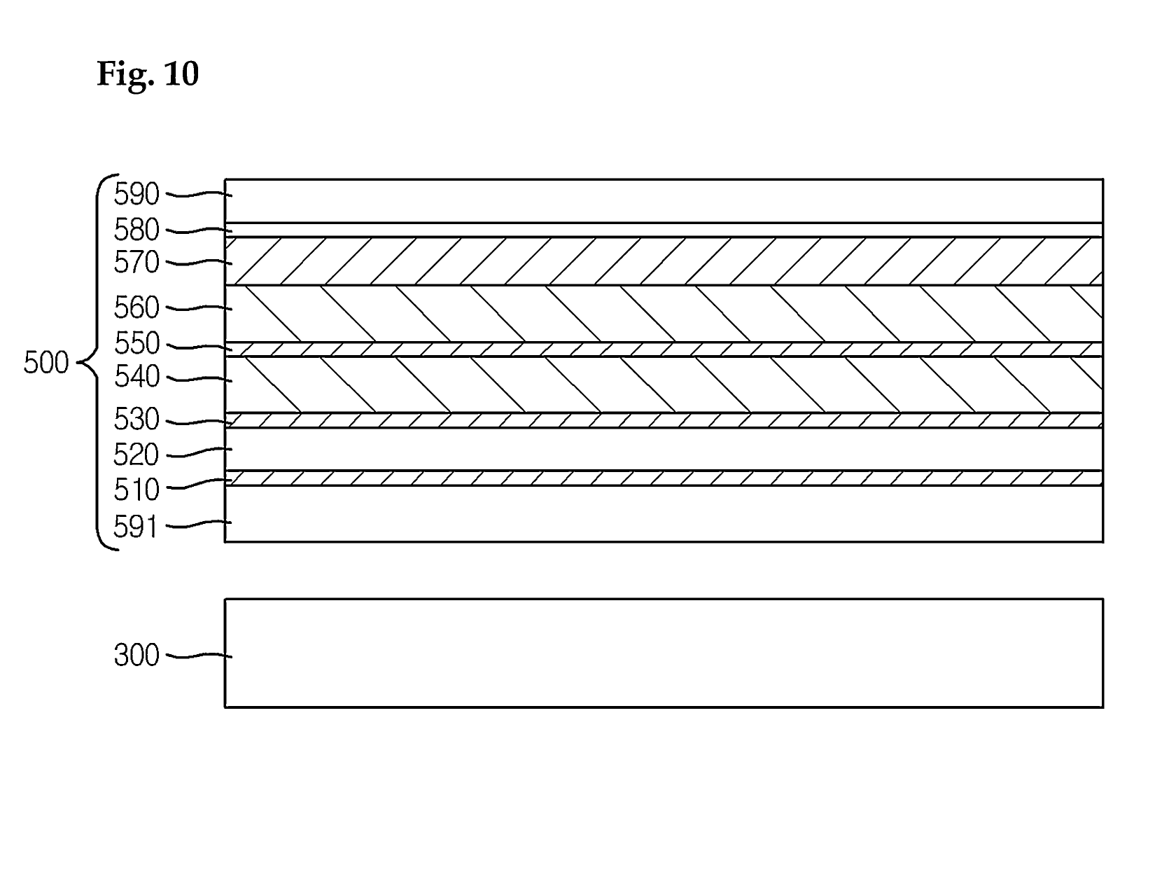

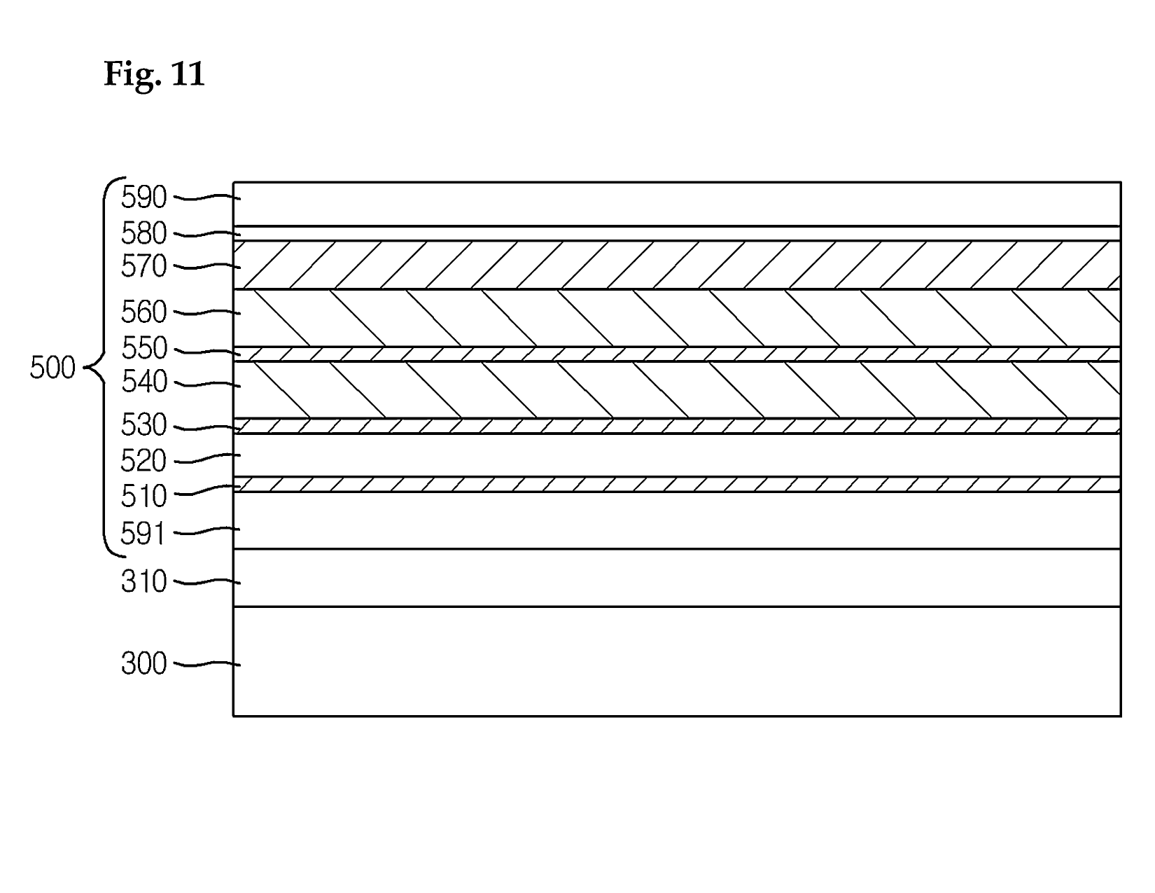

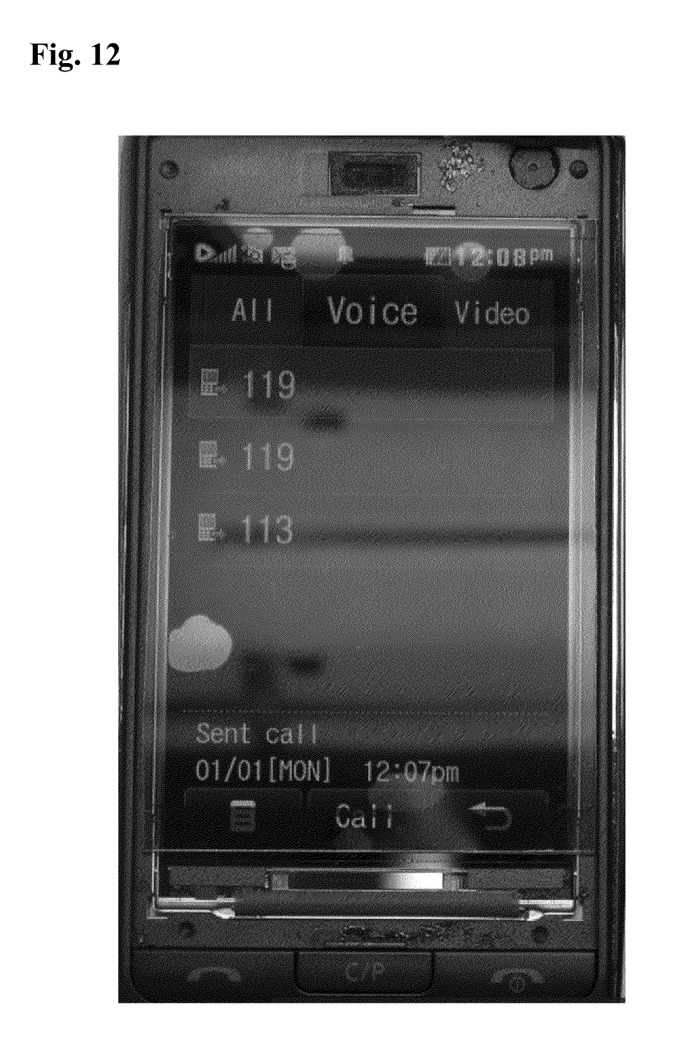

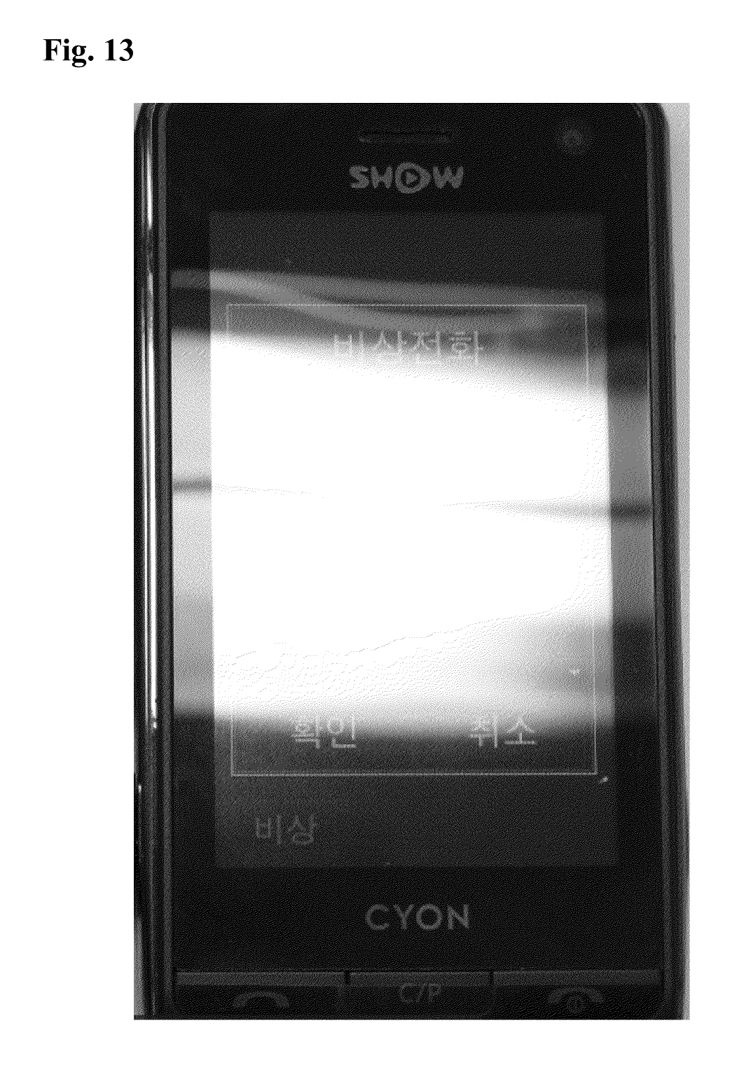

FIG. 10 is a conceptual cross-sectional view explaining a touch screen of a second exemplary embodiment applied with a transparent electrode film according to the present disclosure, FIG. 11 is a conceptual cross-sectional view explaining another example of a touch screen of a second exemplary embodiment applied with a transparent electrode film according to the present disclosure, FIG. 12 is a photograph of a touch screen of a circularly polymeric method applied with a transparent electrode film according to the present disclosure, and FIG. 13 is a photograph of a touch screen of a non-circular polymeric method applied with an ITO film according to a comparative example of the present disclosure.

Referring to FIG. 10, the touch screen according to the second exemplary embodiment of the present disclosure includes an isotropic film 520, a first retarder 540 positioned at an upper surface of the isotropic film 520, a second retarder 560 positioned at an upper surface of the first retarder 540, a laminated structure including transparent electrodes 510, 530, 550 formed on each of the isotropic film 520, the first retarder 540 and the second retarder 550 with any one of Ag-wire ink, a conductive polymer and a graphene, a touch panel 500 including a polarizer 570 formed on the laminate structure, and a display panel 300 coupled to the touch panel 500.

That is, the laminate structure includes the isotropic film 520, the first retarder 540, the second retarder 560 and transparent electrodes 510, 530, 550.

As in the first exemplary embodiment of the present disclosure, the touch panel 500 may further include a window substrate 590 bonded to the polarizer 570 using an adhesive 580, and the isotropic film 520 may be formed with a PMMA (PolyMethyMethAcrylate) layer 591.

At this time, the transparent electrodes 510, 530, 550 may be interposed between the first retarder 540 and the second retarder 560, between the second retarder 560 and the isotropic film 520 and between the isotropic film 520 and the PMMA layer 591. Furthermore, the display panel 300 may be separated from the PMMA layer 591 as shown in FIG. 11 and the display panel 300 may be bonded to the PMMA layer 591 using an adhesive 310, as shown in FIG. 9.

Hence, the touch screen according to the second exemplary embodiment of the present disclosure has also an advantageous effect in that the touch screen includes the first and second retarders 540, 560 and the polarizer 570, and is driven by way of the circularly polarizing method to thereby improve visibility of the screen.

Furthermore, as illustrated in FIG. 13, the touch screen is applied with an ITO film, and with transparent electrodes formed with any one of an Ag-wire ink, a conductive polymer and a graphene over the comparative example which is a touch screen of non-circularly polarizing method, such that it can be learned that the touch screen applied with the circularly polarizing method, as illustrated in FIG. 12, is highly excellent in terms of degree of recognizing characters and graphic on a display panel of a mobile terminal under an outside light environment. That is, it should be apparent that the touch screen according to the present disclosure has a structure configured to reduce reflection of outside light and to thereby improve visibility.

Although the present disclosure has been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of subject combination arrangement within the scope of the disclosure, the drawings and the appended claims. In addition to variations and modifications in the component parts and/or arrangements, alternative uses will also be apparent to those skilled in the art.

What is claimed is:

1. A transparent electrode film structure, the structure comprising:
a retarder film;
an optical layer formed on the retarder film; and
a transparent electrode film formed on the optical layer and consisting of a conductive polymeric film or a graphene.

2. The structure of claim 1, further comprising first and second hard coating layers coated on both surfaces of the retarder film, wherein the optical layer is formed on any one layer of the first and second hard coating layers.

3. The structure of claim 1, wherein the optical layer has a stacked structure with at least two or more layers.

4. The structure of claim 3, wherein the stacked optical layer is alternately stacked with a high refractive layer and a low refractive layer.

5. The structure of claim 1, wherein the retarder film is a COP (Cyclic Olefin Polymer) film or a COC (Cyclic Olefin Copolymer) film.

6. A touch screen, the touch screen comprising:
a first retarder;
a laminate structure formed on the first retarder and including a transparent electrode formed with any one of an Ag-wire ink, a conductive polymer and a graphene formed on at least one or more isotropic films; a second retarder formed on the laminate structure;
a touch panel including a polarizer formed on the second retarder; and a display panel coupled to a first retarder side of the touch panel.

7. The touch screen of claim 6, wherein the first retarder is further formed with a PMMA layer, and the display panel is separated from or bonded to the PMMA layer.

8. The touch screen of claim 6, wherein the first retarder or the second retarder is any one of a 1λ/4 plate, a 1λ/2 plate and a 3λ/4 plate.

9. The touch screen of claim 6, wherein the first retarder or the second retarder is a COP (Cyclic Olefin Polymer) film or a COC (Cyclic Olefin Copolymer) film.

10. The touch screen of claim 6, wherein light incident from outside is converted to a circularly polarized light of any one direction while passing the polarizer and the second retarder.

11. The touch screen of claim 10, wherein the second retarder converts a light reflected from the light incident from the outside to a linear polarized light.

12. The touch screen of claim 6, wherein light emitted from the display panel is converted to a circularly polarized light of any one direction while passing the first retarder, and converted to a linear polarized light parallel with a polarizing axis of the polarizer while passing the second retarder.

13. A touch screen, the touch screen comprising:
an isotropic film;
a first retarder positioned at an upper surface of the isotropic film;
a second retarder positioned at an upper surface of the first retarder;
a transparent electrode formed on each of the isotropic film, the first retarder and the second retarder with any one of Ag-wire ink, a conductive polymer and a graphene;
a touch panel including a polarizer formed on an upper surface of the second retarder; and
a display panel coupled to the touch panel.

14. The touch screen of claim 13, wherein the isotropic film is further formed with a PMMA layer, and the display panel is separated from or bonded to the PMMA layer.

15. The touch screen of claim 13, wherein a transparent electrode is interposed between the first retarder and the second retarder, between the second retarder and the isotropic film and between the isotropic film and the PMMA layer.

16. The touch screen of claim 13, wherein the first retarder or the second retarder is any one of a 1λ/4 plate, a 1λ/2 plate and a 3λ/4 plate.

17. The touch screen of claim 13, wherein the first retarder or the second retarder is a COP (Cyclic Olefin Polymer) film or a COC (Cyclic Olefin Copolymer) film.

18. The touch screen of claim 13, wherein light incident from outside is converted to a circularly polarized light of any one direction while passing the polarizer and the second retarder.

19. The touch screen of claim 13, wherein the second retarder converts a light reflected from the light incident from the outside to a linear polarized light.

20. The touch screen of claim 13, wherein light emitted from the display panel is converted to a circularly polarized light of any one direction while passing the first retarder, and converted to a linear polarized light parallel with a polarizing axis of the polarizer while passing the second retarder.
